(19) United States
(12) Patent Application Publication
(10) Pub. No.: US 2022/0172071 A1
(43) Pub. Date: Jun. 2, 2022

(54) SYSTEM AND METHOD FOR CANDIDATE ENGAGEMENT

(71) Applicant: JIO PLATFORMS LIMITED, Ahmedabad (IN)

(72) Inventors: Harjeet KHANDUJA, Mumbai (IN); Hitesh KHATRI, Kharghar (IN); Umang MATHUR, Bareilly (IN); Parul GARG, Delhi (IN); Rahul MUKHERJEE, Mumbai (IN); Kaushik CHANIYARA, Mumbai (IN); Prateek AWASTHI, Mumbai (IN); Sanjog KARANDE, Mumbai (IN); Avijit KAR, Mumbai (IN)

(73) Assignee: JIO PLATFORMS LIMITED, Ahmedabad (IN)

(21) Appl. No.: 17/456,874

(22) Filed: Nov. 29, 2021

(30) Foreign Application Priority Data
Nov. 30, 2020 (IN) 202021052164

(51) Int. Cl. G06N 3/08; G06V 40/16; G06Q 30/02

(52) U.S. Cl. CPC G06N 3/088; G06Q 30/0217; G06V 40/16

(57) ABSTRACT

The present invention relates to a system and a method for conducting life-cycle engagement of a candidate without human intervention on device engagement architecture. The implementation involves selecting initially, from a plurality of potential candidates based on any or a combination of pre-screening based on a set of pre-defined requirement rules and assessment with respect to multiple engagement criteria. An artificial intelligence (AI) engine associated with the system, evaluates the candidate based on responses to one or more responsive video frames generated by the AI engine. Based on a combination of the pre-screening, the assessment, and the AI engine based evaluation, the system generates a score for the at least one candidate, wherein the candidate is finally engaged based on the generated score.

### FIELD OF INVENTION

The embodiments of the present disclosure generally relate to life-cycle engagement of a candidate. More particularly, the present disclosure relates to a system and method for conducting a life-cycle engagement of a candidate without manual intervention.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In the last few decades, organizations have been investing considerably in hiring talented resources for various roles/positions that may involve either mass recruitment or filling up individual vacant positions. Such a process may completely involve human participation, wherein a pool of applications may be screened manually, to shortlist a few candidates based on various criteria. This may be followed by conducting mass interviews/written test to assess abilities and skillsets of the candidates, which further involve final round of interviews for the shortlisted individuals. This entire process can be very tedious and time-consuming, thereby leading to a significant delay in filling up the vacancies, which may in turn affect smoother functioning of the organization.

Further, there is a high possibility that manually conducted interviews may not lead to uniform/consistent assessment as the manner of evaluation may vary with the skillset of the recruiting individual. This may also cause the organization to lose strong candidates who may not have been assessed correctly. In addition, it may be possible that the hiring may be based on false recommendation/influence, which may lead to faulty assessment thus making it impossible for thorough scrutiny of a person's skillset. Such hiring can eventually impact the positive growth and development of an organization. The manually conducted recruitment may also involve high costs as the interviews need to be conducted by experienced/senior professionals of the organization. At times, companies also tend to outsource recruitment task to a third party, which as well adds to the costs.

Furthermore, the above described conventional process may only be the initial steps in the hiring process and can further involve on-boarding of the candidates based on verification of their educational certificates and other identity documents. This step may not only demand manual and financial resources but also may not be reliable as manual verification of certificates/documents may not be able to substantiate any fraudulency or submission of fake information/documents and hence this can be risky to the reputation of any organization. Thus, the overall process of engagement of a candidate by conventional means can be not only costly and time-consuming but also may not he authentic as it invokes manual intervention and relies solely on human judgement.

There is therefore a need in the art to provide a system and a method that can conduct life-cycle engagement of a candidate without human intervention and at the same time can be efficient, faster, cost-effective and reliable.

### Objects of the Present Disclosure

Some of the objects of the present disclosure, which at least one embodiment herein satisfies are as listed herein below.

It is an object of the present disclosure to provide a system and a method for conducting a life-cycling engagement of a candidate without the need for manual intervention.

It is an object of the present disclosure to provide a system and a method for conducting a life-cycling engagement of a candidate that involves uniformity and accuracy in assessment for engaging the best-skilled candidates for a vacancy.

It is an object of the present disclosure to provide a system and a method that can provide a robust solution for authenticating or verifying candidate information/documents at on-boarding stage to avoid any fraud incidents.

It is an object of the present disclosure to provide a system and a method that can save time as well as enable a full-proof system for identifying the right candidates thereby automating the engagement process and preventing the need for human resources, which makes the system and method not only cost-effective but also fast, reliable and ingenious.

### SUMMARY

This section is provided to introduce certain objects and aspects of the present invention in a simplified form that are further described below in the detailed description. This summary is not intended to identify the key features or the scope of the claimed subject matter.

In order to achieve the aforementioned objectives, the present invention provides a system and method for conducting life-cycle engagement of a candidate without human intervention on device engagement architecture. In an aspect, the system includes a processor that executes a set of executable instructions that are stored in a memory, upon which execution. The processor may cause the system to select initially, from a plurality of potential candidates, at least one candidate based on any or a combination of pre-screening of the plurality of candidates based on a set of pre-defined requirement rules, and assessment with respect to multiple engagement criteria. The initial selection may be performed automatically based on responses of each of the plurality of potential candidates to real-time queries being generated in view of the multiple engagement criteria, wherein candidature of the plurality of potential candidates may be received in response to a released vacancy that is determined based on a set of pre-defined vacancy rules. The at least one candidate may be evaluated, through an artificial intelligence (AI) engine, based on responses to one or more responsive video frames generated by the AI engine. In an embodiment, the one or more responsive video frames may be indicative of a second set of queries, wherein each of the second set of queries may be generated based on response by the least one candidate to the previous query, Further, based on a combination of the pre-screening, the assessment, and the AI engine based evaluation, a score may be generated for the at least one candidate, wherein the candidate may be finally engaged based on the generated score.

In another aspect, the present disclosure includes method for conducting life-cycle engagement of a candidate without human intervention. The method may be executed by a processor, and includes the steps of: selecting initially, from a plurality of potential candidates, at least one candidate based on any or a combination of pre-screening of the plurality of candidates based on a set of pre-defined requirement rules, and assessment with respect to multiple engagement criteria, wherein the initial selection may be performed automatically based on responses of each of the plurality of potential candidates to real-time queries being generated in view of the multiple engagement criteria. The candidature of the plurality of potential candidates may be received in response to a released vacancy that may be determined based on a set of pre-defined vacancy rules. The method includes evaluating, through an AI engine, the at least one candidate, based on responses to one or more responsive video frames generated by the AI engine, wherein the one or more responsive video frames may be indicative of a second set of queries, wherein each of the second set of queries may be generated based on response by the least one candidate to a first set of queries. The method includes generating a score for the at least one candidate, based on a combination of the pre-screening, the assessment, and the AI engine based evaluation, wherein the candidate may be finally engaged based on the generated score.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture (100) in which or with which the system of the present disclosure can be implemented, in accordance with an embodiment of the present disclosure.

FIG. 2A illustrates an exemplary representation (200) of system (110) or a centralized server (112), in accordance with an embodiment of the present disclosure.

FIG. 2B illustrates an exemplary representation (250) depicting an artificial neural network associated with an artificial intelligence (AI) engine (216) of system (110), in accordance with an embodiment of the present disclosure.

FIG. 2C illustrates an exemplary representation depicting neural network based candidate profile integrity verification system architecture (280), in accordance with an embodiment of the present disclosure.

FIG. 3A illustrates an exemplary representation (300) of block chain component (120) for profile and integrity verification of a candidate, in accordance with an embodiment of the present disclosure.

FIGS. 3B and 3C illustrate exemplary Blockchain based candidate document and image upload and verification systems (350 and 360), in accordance with an embodiment of the present disclosure.

FIG. 3D illustrates exemplary Blockchain Sub-Module diagram showing Candidate Profile Integrity Verification System (370), in accordance with an embodiment of the present disclosure.

FIG. 3E illustrates an exemplary method flow diagram (380) for blockchain based candidate Profile Integrity verification System architecture, in accordance with an embodiment of the present disclosure.

FIG. 4 illustrates exemplary method flow diagram (400) depicting a method for conducting life-cycle engagement of a candidate without human intervention on device engagement architecture, in accordance with an embodiment of the present disclosure.

FIG. 5 illustrates a representation (500) of the exemplary overview showing the workability of system (110) and method (400), in accordance with an embodiment of the present disclosure.

FIG. 6 illustrates an exemplary table (600) indicating weight associated with each candidate attribute/parameter, in accordance with an embodiment of the present disclosure.

FIG. 7 refers to the exemplary computer system (700) in which or with which embodiments of the present invention can be utilized, in accordance with embodiments of the present disclosure.

The foregoing shall be more apparent from the following more detailed description of the invention.

### BRIEF DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details, Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will he understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics array be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention provides solution to the above-mentioned problem in the art by providing a system and a method for efficiently conducting life-cycle engagement of a candidate without human intervention on device engagement architecture. Particularly, the system and method provide a solution where the candidate can be selected from a plurality of potential candidates based on pre-screening and assessment, and further evaluated without any manual intervention, by the ingenious implementation of artificial intelligence (AI) engine, wherein a final candidate can be engaged based a generated score that takes all the essential aspects of pre-screening, assessment and AI based evaluation into account. Further, another unique aspect of the present disclosure involves the implementation of block chain technology that can enable a profile and integrity verification of the engaged candidate as well as enable assignment of identification information to the engaged candidate upon joining. Thus, the system and method of the present disclosure can enable to automate the engagement and verification process, thereby facilitating a faster, consistent and reliable operation that does not require manual intervention and hence is devoid of the disadvantages associated thereto.

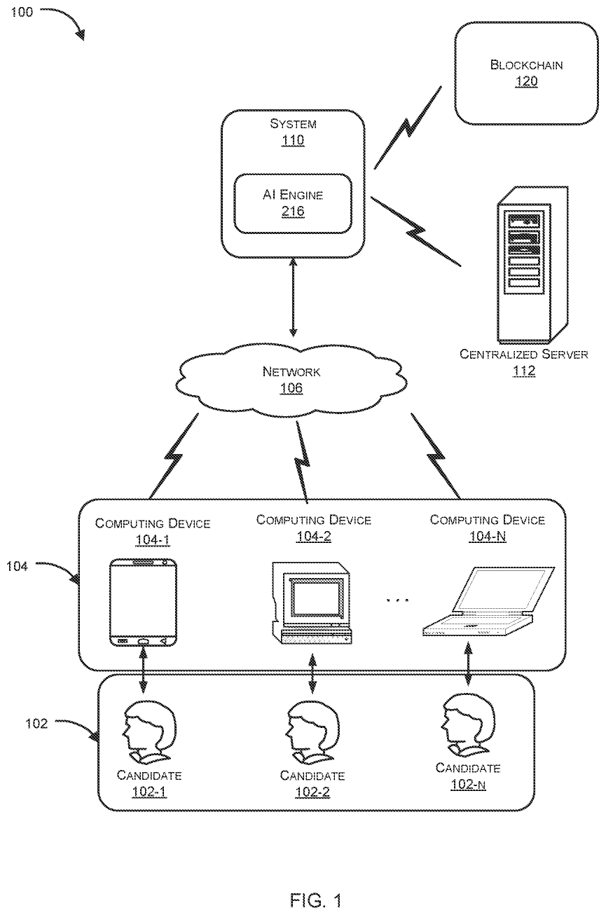

Referring to FIG. 1 that illustrates an exemplary network architecture (100) in which or with which system (110) of the present disclosure can be implemented, in accordance with an embodiment of the present disclosure. As illustrated, the exemplary architecture (100) includes a system (110) equipped with an artificial intelligence (AI) engine (216) for conducting life-cycle engagement without human intervention on device engagement architecture. The engagement can be enabled by selection from a plurality of potential candidates (102-1, 102-2, . . . 102-n) (hereinafter interchangeably referred as a potential candidate or a candidate or candidates; and collectively referred to as 102. Each potential candidate may be associated with at least one computing device (104-1, 104-2, . . . 104-n) (hereinafter interchangeably referred as a smart computing device or candidate device; and collectively referred to as 104). The candidates (102) may interact with the system (110) by using their respective computing device (104), wherein the computing device (104) and the system (110) may communicate with each other over a network (106). The system (110) may be associated with a centralized server (112) and a blockchain (120).

In accordance with an embodiment and as illustrated in FIG. 1, the architecture can enable candidates to access information related to a released. vacancy, in response to which each candidate can submit their candidature using their respective computing devices (104). Based on a set of pre-defined vacancy rules, the system (110) can determine plurality of potential candidates (102), from which, the system (110) can further select one or more candidates based on pre-screening and assessment. Using the AI engine (216) in the system (110), the selected candidate (110) can be evaluated based on responses to one or more responsive video frames generated by the AI engine, wherein the one or more responsive video frames may be indicative of a second set of queries generated based on response by the least one candidate to a first set of queries. The system (110) can generate a score based on a combination of the pre-screening, the assessment and the AI based evaluation. The generated score can be used by the system (110) to engage candidate. The system thus completely eliminates the need for any human intervention.

In an embodiment, vacancy can be automatically released by the system (110) based on a set of pre-defined vacancy rules. The pre-defined vacancy rules can be applicable to a selected set of positions such that a vacancy may be released upon termination of a role of an existing engaged member (hereinafter interchangeably referred to as an engaged member or an engaged personnel or a member). The pre-defined vacancy rules may be applicable to any one of a wilful termination such as resignation or a forced termination such that the vacancy may be tilled on any of a temporary or a permanent basis. In an embodiment, the system (110) may enable posting or advertising about the released vacancy so that the potential candidates (102) can access the vacancy and the relevant information, and submit their candidature accordingly. The candidature submitted by all the potential candidates may be used for further pre-screening and assessment by the system (110). The candidature may be submitted by the candidates using their respective computing devices (104) by transmission of data packets to the system (110) through network (106), wherein the data packets may be in form of a prescribed filled form or any other template, which may be provided via a set of instructions on the computing device (104) based on information related to the pre-defined vacancy rules.

In an embodiment, plurality of potential candidates (102) can access the information of the released vacancy by using their respective computing devices via set of instructions residing on any operating system, including but not limited to, Android™, iOS™, and the like. In an embodiment, computing device (104) may include, but not limited to, any electrical, electronic, electro-mechanical or an equipment or a combination of one or more of the above devices such as mobile phone, smartphone, virtual reality (VR) devices, augmented reality (AR) devices, pager, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen and the like. It may be appreciated that the computing device (104) may not be restricted to the mentioned devices and various other devices may he used. A smart computing device may be one of the appropriate systems for storing data and other private/sensitive information.

In an embodiment, the system (110) may select one or more candidates from the list of potential candidates (102) based on any or a combination of two crucial factors i.e. pre-screening and assessment. The pre-screening may enable preliminary screening to check if the candidature may fulfil all basic requirements of the released vacancy based on which further assessment may be done. In an embodiment, the set of pre-defined requirement rules may include candidate profile screening rules that may take into account the nature of the released vacancy and determine one or more criteria to be present in the candidature including, but not limited to, age, educational qualification, gender, skill-set, professional experience, languages known, willingness to travel, physical disabilities, completed certifications and the like. In an embodiment, based on the results of the pre-screening, if candidature is found to be satisfying in view of the pre-defined requirement rules, the candidate is further assessed with respect to multiple engagement criteria.

In an embodiment, the multiple engagement criteria for assessment may involve generation of real-time queries that may be posed to the potential candidates (102) and the response of each potential candidate may be utilized by the system (110) to determine initial selection of candidates for further evaluation. In an embodiment, the multiple engagement criteria can include aptitude-based evaluation, technical evaluation, and behavioural evaluation based on which the real-time queries may be presented to the candidate under consideration. The aptitude based evaluation may be able to test the aptitude of the candidate with respect to the released vacancy, whereas the technical evaluation may test the technical knowledge and expertise of a candidate in a subject matter related to the released vacancy and the behavioural evaluation may analyse the attitude, philosophical approach and/or thought process of a candidate to understand his/her strength and weakness. In an exemplary embodiment, real time queries may he presented to the candidates during assessment to determine aptitude, technical knowledge or additional skills or emotional/intellectual qualities of candidates.

In an embodiment, based on the initial selection of the candidates, the further evaluation of the candidates may be done by AI engine (216) of the system (110). In this evaluation, a first set of queries may be generated and based on the response of each selected candidate, one or more responsive video frames may be generated by the AI engine (216) such that based on the response, the candidate may be evaluated, wherein the one or more responsive video frames may be indicative of a second set of queries. The AI engine (216) may generate first/second set of queries/responsive video frames related to, without limitation, an aptitude required for the released vacancy, emotional intelligence, intellectual ability, personal history, general awareness, perspective/opinion, communication skills, leadership abilities and the like. The AI engine may thus prove to be an ingenious component that can mimic the role of manual evaluation by posing the right set of queries to the candidate each time that may enable effective evaluation and enhance consistency of evaluation that may not possible in case of human based evaluation wherein the evaluating person may he different for different candidates. In an exemplary embodiment, the candidate may interact with AI component of the system (110) by way of video based conversation in which the candidate may be asked the first set of queries, wherein a camera/visual sensor present on computing device (104) of the candidate (102) may enable the video based response of the candidate to the first set of queries based on which the AI engine may generate one or more responsive video frames indicative of a second set of queries, such that the response may be recorded by the system (110) for later evaluation. The responsive video frames may be generated by AI engine (216) in real time based on the recorded candidate response.

In an embodiment, based on a combination of the pre-screening, the assessment, and the AI engine based evaluation, a score may be generated for the candidate (102), wherein the candidate (102) may be finally engaged based on the generated score. In an exemplary embodiment, the score may be in form of number or grades, such that a threshold score may be set based on the type of the released vacancy wherein based on the score of the candidate being beyond the threshold score, the candidate may be engaged.

In an embodiment, AI engine can be operatively coupled with and/or include a video analysis engine that can be configured to receive video frames as part of the responses being sent by candidates and perform any or a combination of microfacial expression analysis, tone modulation analysis, facial recognition, background analysis, movement analysis, response content analysis, and gesticulation analysis in order to output, for each candidate, matching of candidate's attributes/parameters with the vacancy role description. In an aspect, the fitness for a given vacancy role description can be determined based any or a combination of communication skills (such as body language, clarity, and communication style), technical skills (such as response analysis and technical know-how), personality (such as big5 parameters and professionalism), and cultural fitment (such as language, formality level, customer focus, demographics, and competitiveness) of the candidate.

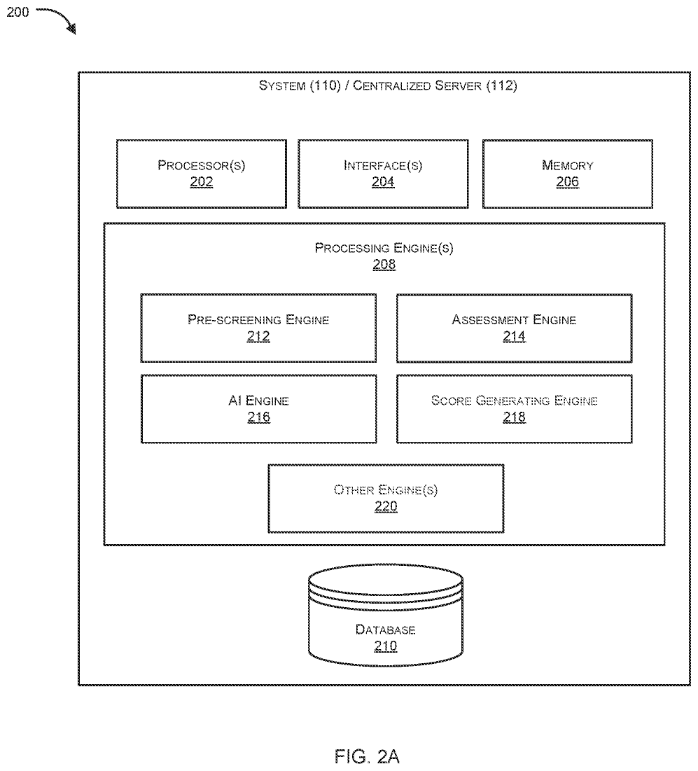

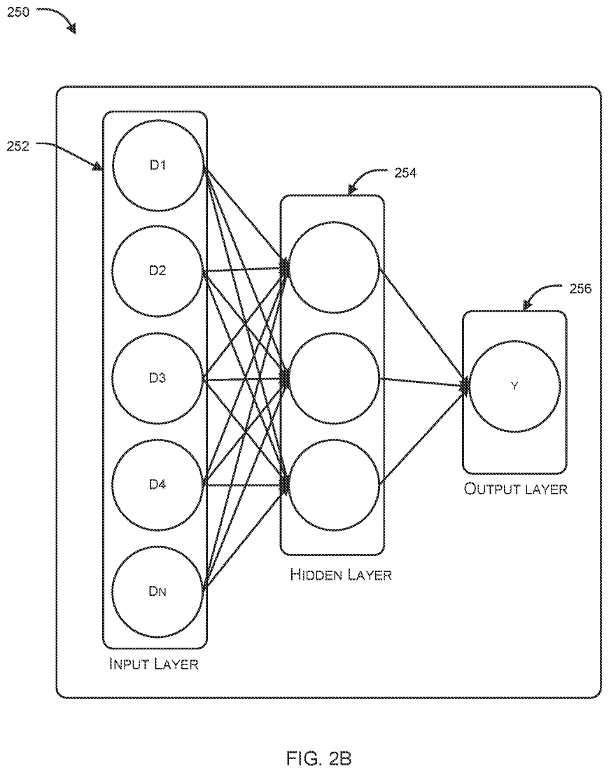

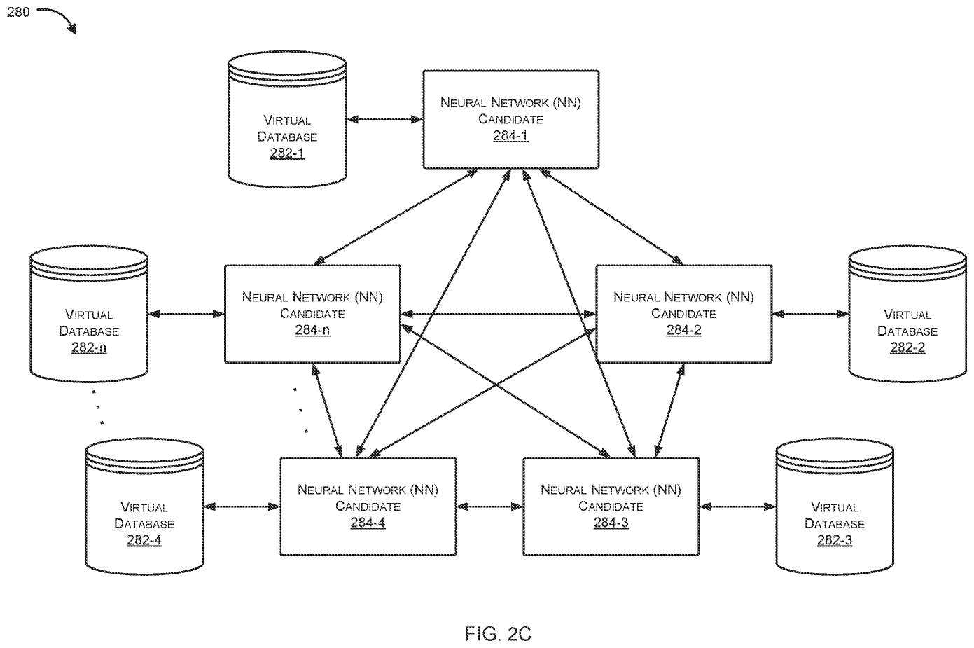

In an embodiment, the system (110) for conducting life-cycle engagement may include one or more processors coupled with a memory, wherein the memory may store instructions which when executed by the one or more processors may cause the system to perform the selection, evaluation and score generation steps as described hereinabove. FIG. 2 with reference to FIG. 1, illustrates an exemplary representation of system (110)/centralized server (112) for conducting life-cycle engagement of candidate (102), in accordance with an embodiment of the present disclosure. In an aspect, the system (110)/centralized server (112) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (102). The memory (204) may be configured to store one or more computer-readable instructions or routines in a non-transitory computer readable storage medium, which may be fetched and executed to create or share data packets over a network service. The memory (206) may comprise any non-transitory storage device including, for example, volatile memory such as RAM, or non-volatile memory such as EPROM, flash memory, and the like.

In an embodiment, the system (110)/centralized server (112) may include an interface(s) 204. The interface(s) 204 may comprise a variety of interfaces, for example, interfaces for data input and output devices, referred to as I/O devices, storage devices, and the like. The interface(s) 204 may facilitate communication of the system (110). The interface(s) 204 may also provide a communication pathway for one or more components of the centralized server (112). Examples of such components include, but are not limited to, processing engine(s) 208 and a database 210.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110)/centralized server (112) may comprise the machine-readable storage medium storing the instructions and the processing resource to execute the instructions, or the machine-readable storage medium may be separate but accessible to the system (110)/centralized server (112) and the processing resource. In other examples, the processing engine(s) (208) may be implemented by electronic circuitry.

The processing engine (208) may include one or more engines selected from any of a pre-screening engine (210), an assessment engine (214), AI engine (216), score generating engine (218) and other engines (220). In an embodiment, the pre-screening engine (210) may enable to compare information related to candidature of a candidate with set of pre-defined requirement rules corresponding to released vacancy, such that upon verifying if all essential requirements of the released vacancy are satisfied, the pre-screening engine may indicate that the candidature is suitable for further assessment with respect to multiple engagement criteria. In an embodiment, the assessment engine (214) may enable to generate real-time queries for plurality of potential candidates (102), and further may evaluate the response by comparison with pre-defined attributes related to the multiple engagement criteria corresponding to the released vacancy.

In an embodiment, the AI engine (216) may include an artificial neural network (250) involving neurons (represented as circles) as indicated in FIG. 2B, wherein the neural network may have three basic layers including input layer (252), hidden layer (254) and output layer (256). The hidden layer (254) may be between the input layer (252) and output layer (256), wherein the artificial neurons may take in a set of weighted inputs (shown as D1, D2, D3, D4 . . . , Dn) and produce an output (Y) through an activation function. In a general sense, “artificial intelligence” is related to machines such as computers that can mimic cognitive functions similar to that displayed by human mind, such as learning or problem-solving abilities. In an embodiment of the present disclosure, the artificial neural network (250) of the AI engine (216) can involve a learning phase and a testing phase to enable the AI engine (216) to mimic human evaluation. During the learning phase, a huge volume of input data may be fed to the input layer (252) of the neural network, and an estimated output may be checked for loss/error value. The evaluation ability (such as ability to evaluate candidate response) or the ability of the AI engine (216) to generate responsive video frames based on the response of candidates during evaluation, may keep getting more accurate with more volume of data fed to the input layer during, the training phase. In an embodiment, the input layer (252) can involve multiple input information fed to the input layer, wherein such input data may include queries and/or answers related to, without limitation, aptitude required for the released vacancy, emotional intelligence, intellectual ability, personal history, general awareness, perspective/opinion, communication skills, leadership abilities and the like. Once trained, in the testing phase, the AI engine (216) can automatically generate queries in real time and also evaluate the responsive video frames, as well as can generate a score with high accuracy/precision based on pre-screening, assessment and evaluated responsive video frames.

In an exemplary embodiment, AI engine can be configured to analyse each candidate based on multiple attributes/factors, including but not limited to, emotional analysis such as the facial/expressions/gestures of the candidate (for example, happy, sad, fear, angry, excited), sentiment analysis (for example, positive, negative, and neutral), speech analysis (for example, confidence, attitude, communication, relevance with role description), personal analysis (for example, age, gender, BMI, health parameters, dizziness, and facial analysis), and multi-face analysis (for example, digital copy, front face, side face, eye blink, and face rotations).

In an embodiment, the score generating engine (218) may generate a score based on the combination of the pre-screening, the assessment, and the AI engine based evaluation. In an embodiment, the other engines (220) may include a candidate offer engine for initiating an engagement offer upon selection of candidate, a candidate onboarding engine to enable assistance with onboarding process and other engines to enable with one or more steps in the engagement process. The database (210) may comprise data that may be either stored or generated as a result of functionalities implemented by any of the components of the processing engine(s) 208 of the system (110)/centralized server (112). The database (210) may also enable to store data fed to the AI engine (216) during learning phase.

In an embodiment, upon a candidate (102) being engaged, based on generated score, the system (110) may transmit a first set of data packets indicative of confirmation of engagement of the candidate (102). In an embodiment, the confirmation may occur in real time. In an exemplary embodiment, the first of data packets may be indicative of compensation and/or location that may be offered to the engaged candidate, wherein offered compensation/location may be based on the performance of the candidate in the overall evaluation process and other aspects such as expected compensation/location as preferred by the candidate, qualification/professional experience of the candidate, availability of the preferred location and the like. In response to the confirmation, the candidate (102) may acknowledge or agree to the confirmation by using their respective computing device, wherein the acknowledgement of the confirmation may be transmitted as a second set of data packets. In an embodiment, the second set of data packets can include one or more document information associated with the engaged candidate. The AI engine may verify the one or more document information in the received second set of data packets, Further, upon successful verification, a third set of data packets may be transmitted to the engaged candidate indicative of pre-boarding of the candidate. In another embodiment, in case the second set of data packets are not transmitted by the computing device in a defined time-duration, the first set of data packets are automatically transmitted to a second candidate having next higher score to the engaged candidate.

In an embodiment, upon a confirmed engagement of the candidate, the processor (202) of the system (110) may perform blockchain based profile and integrity verification of the engaged candidate, upon successful verification of which, a fourth set of data packets may be transmitted to the engaged candidate indicative of joining confirmation of the candidate. As referred herein, the term “blockchain” refers to a collection of records that keep growing and includes blocks that are linked using cryptography, wherein each block contains a cryptographic hash of the previous block, a timestamp, and transaction data, wherein the secure nature of the blockchain is due to its resistance to any modification of the data and wherein the data in any block cannot be altered without altering the subsequent blocks. The system (110) of the present disclosure thus ensures a viable means of authentication for ensuring that forged/fake documents/identity are not submitted, thereby adding an extra layer of security to the engagement process.

FIG. 2C illustrates an exemplary representation depicting neural network based candidate profile integrity verification system architecture (280), in accordance with an embodiment of the present disclosure. As can be seen, the exemplary architecture (280) can include a plurality of virtual databases (282-1, 282-2, 282-3, 282-4 . . . , 282-n, together referred to as Virtual Database 282 hereinafter) that are operatively coupled with Distributed Ledger Technology (DLT) based Neural Network (NN) candidates such as 284-1, 284-2, 284-3, 284-4, . . . , 284-n, together referred to as DLT-NN Candidates 284 hereinafter. The proposed architecture can enable profile and attributes/evaluation test results/AI engine based response data packets among other candidate profile information to be stored in respective candidates' virtual databases and retrieved by the proposed system in real-time in a manner such that the neural network can evaluate each candidate based on his/her respective score, and re-train the system for the candidate screening filters and rules required for improving the efficiency of scoring and/or selecting a candidate and mapping the accuracy of the selected candidate with the candidate description associated with the to-be-engaged candidate. The proposed architecture can enable incorporation of any or a combination of back propagation, learning rate decay curve, and max-pooling, along with stochastic gradient descent as Distributed Ledger methods and any or a combination of generative adversarial network, convolutional neural network, recurrent neural network as DL models.

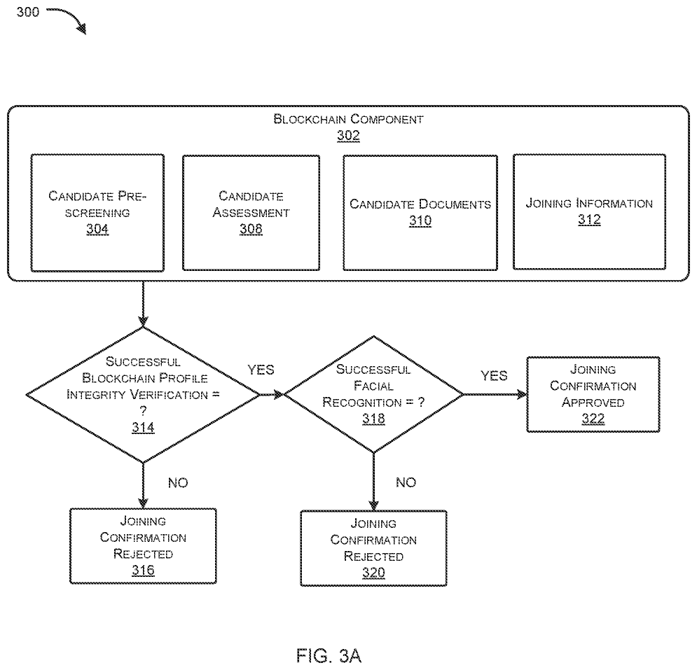

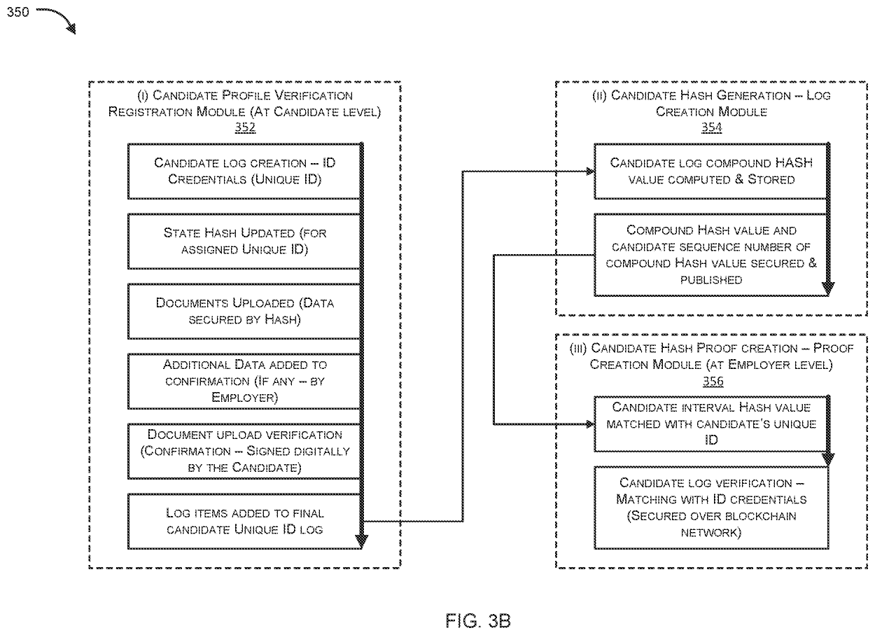

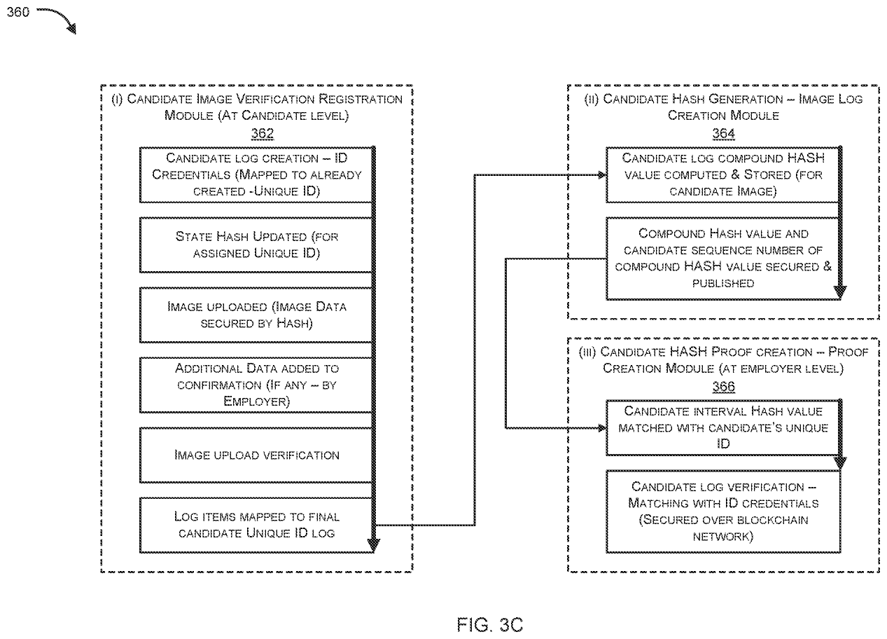

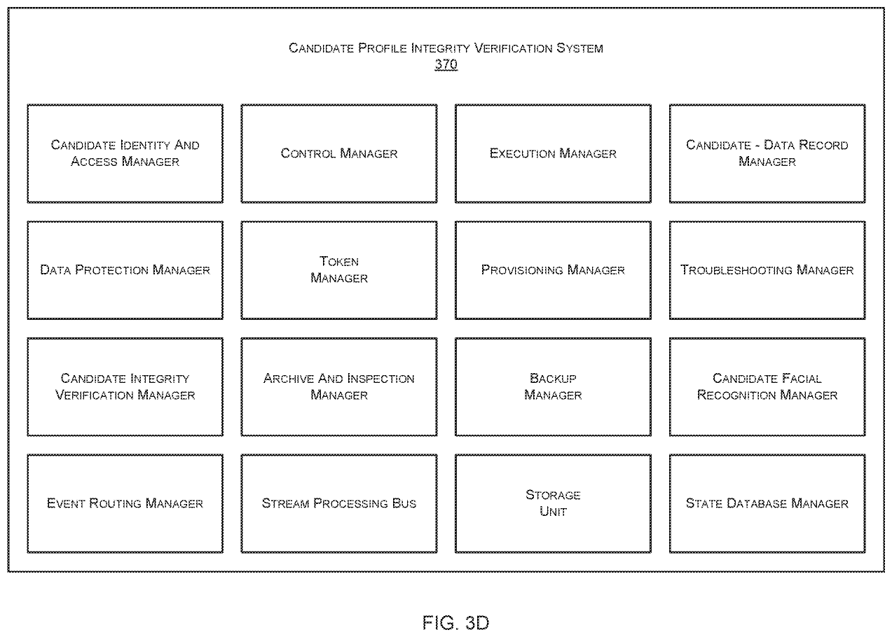

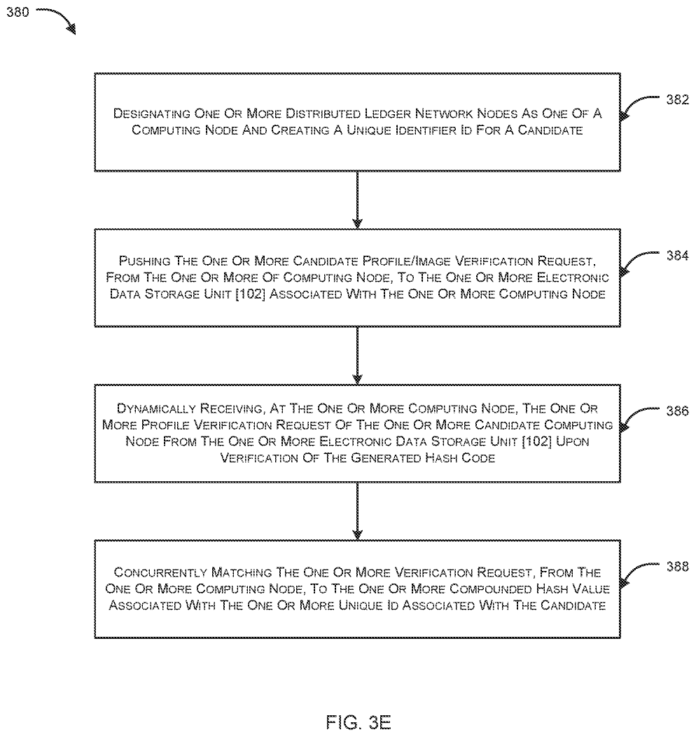

FIG. 3A illustrates an exemplary representation (300) for blockchain based profile and integrity verification of an engaged candidate, in accordance with an embodiment of the present disclosure. As shown in FIG. 3, a blockchain component (302) may include one or more blocks including various information such as candidate pre-screening data (304), candidate assessment data (308), candidate document (310) and joining information of the candidate (312). The candidate pre-screening data (304) may be candidate profile information that may be include earlier submitted candidature or the data analysed at the stage of pre-screening, wherein the data (304) may include, but not limited to, personal information, education, professional experience and the like. The candidate assessment data (308) may be the information obtained at the stage of engagement criteria, assessment and may include, but not limited to, assessment score of the candidate and relevant images of the assessment. The candidate document (310) may be the information/document sent by the candidate at the time of offer acknowledgement and may include, but not limited to, joining information such as probable joining date, relevant documents and offered compensation/locations details or documents. The information in the block chain may be verified and at 314, if the verification concludes that there is error/issue in any of the documents/details then verification may not be successful and joining confirmation may be rejected (316).

In an embodiment, on the date of the joining of the engaged candidate, computing device (104) of the engaged candidate may transmit, to the blockchain, a fifth set of data packets that may be indicative of physical presence and joining of the engaged candidate, in response to which, the processor configures the blockchain to generate a sixth set of data packets indicative of facial recognition verification of the engaged candidate. As shown in FIG. 3, a facial recognition may be performed (318) to initiate the joining procedure, based on which if the facial recognition may be successful then joining confirmation may be approved (322), otherwise the joining confirmation may be rejected (320). In case of failure, the facial recognition step may be performed again. In an embodiment, the facial recognition may be performed using clicking a self-image via a camera on the computing device (104) of the candidate and further transmission of the image via data packets to the system (110). In an embodiment, upon successful facial recognition verification, communication of identification information may be assigned to the engaged candidate. The identification information may include, but not limited to, a code/identity number and network access identity/credentials.

FIGS. 3B and 3C illustrate exemplary Blockchain based candidate document and image upload and verification system 350 and 360, in accordance with an embodiment of the present disclosure. In an aspect, the proposed system 350 can include a candidate profile verification registration unit/module 352 (at candidate level), a candidate Hash Generation—Log Creation Module 354, and a candidate Hash proof creation—proof creation module (at employer level) 356. In an embodiment, candidate profile verification registration unit/module 352 can be configured to create a unique ID for each candidate, update Hash based on the respective assigned/created unique ID, and allow the candidate to upload his/her documents secured by the generated/updated Hash key. Additional information can also be added by the employer/engaging entity based on which the proposed blockchain system can verify the documents uploaded by the candidate, which can include digital signing of the documents and/or the verification attributes by the respective candidate, and the verified items can then be logged to the candidate's final unique identifier log. In another aspect, the log creation module 354 can compute and store the Hash value along with the log, based on which the module can secure and publish the compound Hash value and respective candidates' sequence number of the compound Hash value. Proof creation module 356, in an embodiment, can be configured to match the candidate's interval Hash value with Candidate's unique identifier, post which verification/matching, the candidate's log can be secured on the blockchain network.

With reference to FIG. 3C, the proposed system 360 can include a candidate image verification registration unit/module 362 (at candidate level), a candidate Hash Generation—Image Log Creation Module 364, and a candidate Hash proof creation—proof creation module (at employer level) 366. In an embodiment, candidate image verification registration unit/module 362 can be configured to identify and/or retrieve Identifier (ID) credentials of the candidate which are mapped to already created unique ID, update Hash based on the respective ID credentials, and allow the candidate to upload his/her image secured by the generated/updated Hash key. Additional information can also be added by the employer/engaging entity based on which the proposed blockchain system can verify the image uploaded by the candidate, and accordingly items mapped to the final candidate unique ID log can be logged. In another aspect, the image log creation module 364 can compute and store the Hash value along with the log, based on which the module can secure and publish the compound Hash value and respective candidates' sequence number of the compound Hash value. Proof creation module 366, in an embodiment, can be configured to match the candidate's interval Hash value with Candidate's unique identifier, post which verification/matching, the candidate's log can be secured on the blockchain network.

FIG. 3D illustrates exemplary Blockchain sub-unit diagram showing Candidate Profile integrity Verification System 370, in accordance with an embodiment of the present disclosure. As can be seen, the proposed system 370 can include a candidate identity and access unit, a control unit, an execution unit, and a candidate data record unit, which can be configured to manage and control profiles/attributes/parameters and evaluation/screening outputs of the candidate's assessment. The system 370 can further include a data protection unit, a token unit, a provisioning unit, and a troubleshooting unit to facilitate, manage, protect, trouble-shoot, secure and control transactions and communications between the candidate's computing device and evaluation/AI engine/system. The proposed system 370 can further include other exemplary units including but not limited to a candidate integrity verification unit, an archive and inspection unit, a backup unit, a candidate facial recognition unit, event routing unit, stream processing bus, storage unit, and a state database unit/manager.

FIG. 3E illustrates an exemplary method flow diagram 380 for blockchain based candidate Profile Integrity verification System architecture, in accordance with an embodiment of the present disclosure. At step 382, the method includes the step of designating one or more distributed ledger network nodes as a computing node(s), and creating a unique identifier for each candidate. At step 384, the method includes pushing the one or more candidate profiles and/or image verification requests from the computing node(s) to the one or more electronic data storage unit(s) associated with the computing node(s). At step 386, the method can include dynamically receiving, at the computing node(s), the one or more profile verification requests of the one or more candidate computing node(s) from the respective electronic data storage unit(s) upon verification of the generated Flash code/value, and at step 388, concurrently matching the one or more verification requests from the one or more computing nodes to the one or more compounded/computed hash values associated with the one or more unique IDs that are associated with the respective candidate(s).

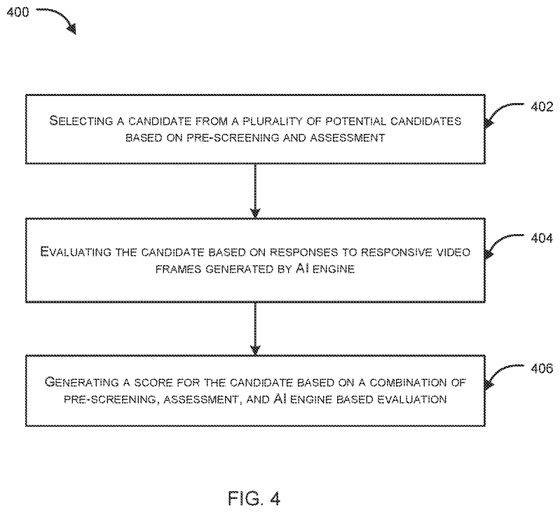

FIG. 4 is a flow diagram illustrating a process for conducting engagement of a candidate without human intervention, in accordance with an embodiment of the present disclosure. At step 402, the method includes the step of selecting initially, from a plurality of potential candidates, at least one candidate based on any or a combination of pre-screening of the plurality of candidates based on a set of pre-defined requirement rules, and assessment with respect to multiple engagement criteria. In an embodiment, the initial selection may be performed automatically based on responses of each of the plurality of potential candidates to real-time queries being generated in view of the multiple engagement criteria. In an embodiment, the candidature of the plurality of potential candidates may be received in response to a released vacancy that can be determined based on a set of pre-defined vacancy rules. At step 404, the method includes the step of evaluating, through an AI engine, the at least one candidate, based on responses to one or more responsive video frames generated by the AI engine. In an embodiment, the one or more responsive video frames may be indicative of a second set of queries, wherein each of the second set of queries may be generated based on a response by the least one candidate to the previous query. At step 406, the method includes the step of generating a score for the at least one candidate, based on a combination of the pre-screening, the assessment, and the AI engine based evaluation, wherein the candidate may be finally engaged based on the generated score.

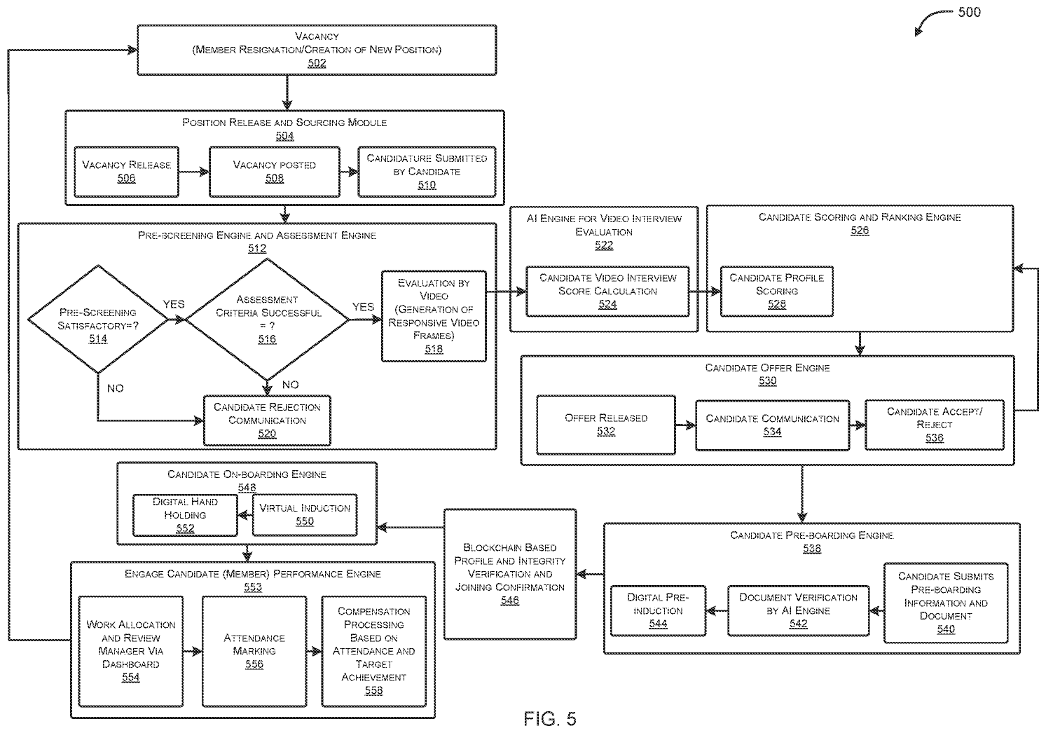

The system and method of the present disclosure may be further described in view of exemplary embodiments. FIG. 5 illustrates an exemplary representation (500) of the overview or workability of the system and method of the present disclosure. At 502, a vacancy may be available due to termination of an existing engaged member or generation of a new position. At 504, a position release and sourcing module (504) in the system (110) may indicate release of a vacancy (506) based on a set of pre-defined vacancy rules, which may be advertised or posted at various platforms (508). At 510, potential candidates may submit their candidature in response to the released vacancy. At 514, a pre-screening engine (512) may perform pre-screening based on a set of pre-defined requirement rules, wherein if the potential candidate fulfils the pre-screening criteria then further assessment may be done, otherwise the candidate rejection may be communicated (520). At 516, the potential candidates clearing pre-screening may be assessed (such as via, aptitude tests) with respect to multiple engagement criteria, such that upon success of the engagement, the further evaluation may be done, otherwise the candidate rejection may be communicated (520). At 518, video based evaluation may be done (such as video interviews), wherein the candidate may be evaluated through an AI engine of system (110), based on responses to one or more responsive video frames generated by the AI engine. The video based evaluation/video frames may be related to a set of queries in response to previous queries. At 524, the AI engine may evaluate the responses to the video frames (522), wherein a score corresponding to the video interview may be calculated by the AI engine. At 528, a score may be generated for the candidate by the score generating engine (526). Based on the score, a candidate offer engine (530) of the system (110) may select (within a week) the highest scoring candidate and release an offer (532) including offered compensation and location as a first set of data packets to the selected candidate (threshold compensation value may be saved in the system). The candidate may receive the communication (534) of the offer via computing device (104) in form of network based communication or message, based on which the candidate may accept the offer (536) by sending an acknowledgement as a second set of data packets via the computing device. If the candidate does not accept the offer within a defined time duration, then the system rejects the offer and sends the same offer to next best candidate with next higher score. At 540, the offered candidate submits pre-boarding information and documents which is received by a pre-boarding engine (538). At 542, the AI engine verifies the documents against the information and at 544, the offered candidate goes through a digital pre-induction module. At 546, the blockchain based profile and integrity verification may take place and possibly on a joining date (decided by system), the candidate may click his/her own picture (for facial recognition) and confirms the joining. At 548, post verification, candidate on-boarding may take place, and the engaged candidate may be provided with a member code and network based identity based credentials (such as email ID), post which a virtual induction (550) and a digital hand-holding (552) may take place to assist the engaged member to understand history and working protocol of organization. The work performance of the engaged member may be assessed by a performance engine (553) wherein work allocation (554) and attendance marking (556) may be enabled, based on which the compensation (558) may he processed at defined time intervals such as after every one month. Further, based on wilful or forced termination of the engaged member, a new vacancy may he released (504 and 504).

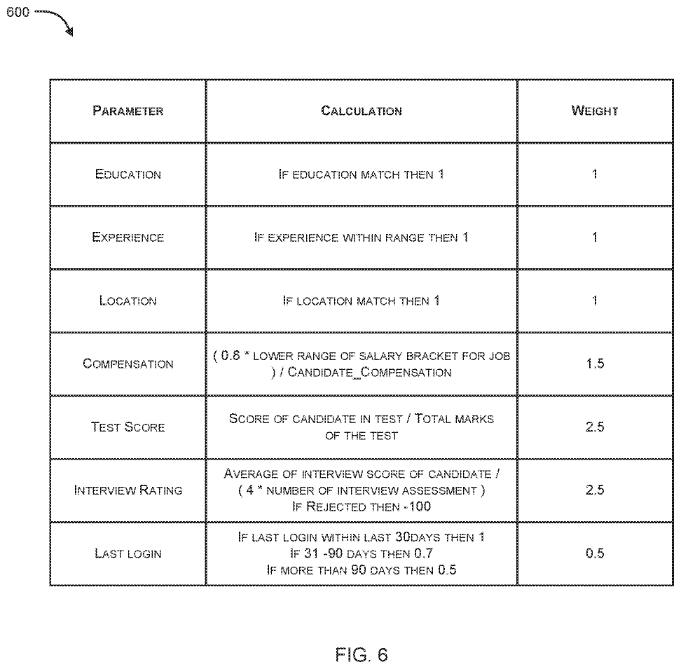

FIG. 6 illustrates an exemplary table (600) indicating weight associated with each candidate attribute/parameter, in accordance with an embodiment of the present disclosure. Candidate parameters, also interchangeably referred to as evaluation or assessment parameters can include but are not limited to education background, work/professional experience, location, compensation, assessment/evaluation test score, AI-engine based interview rating, and last login into the system, each of which parameters can be assigned a pre-defined weight in order to compute the overall score for the candidate.

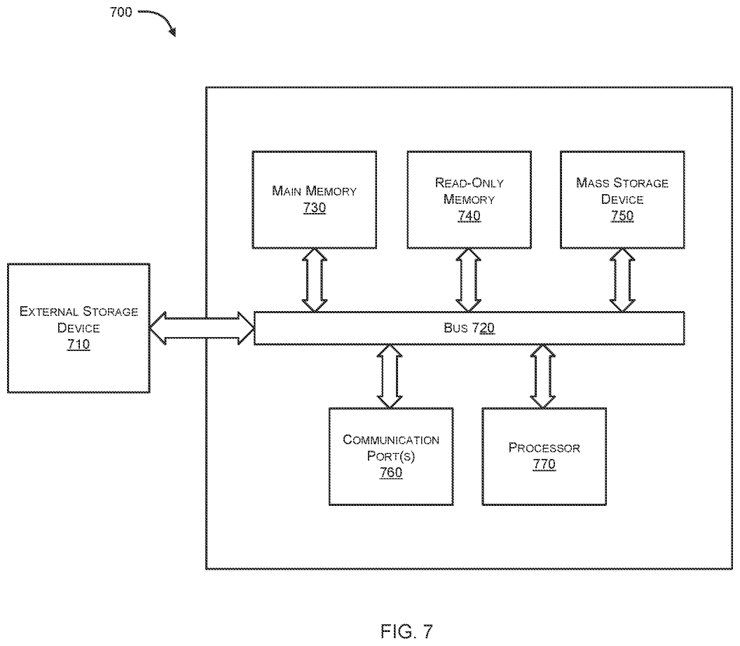

FIG. 7 illustrates an exemplary computer system in which or with which embodiments of the present invention can be utilized in accordance with embodiments of the present disclosure. As shown in FIG. 7, computer system 700 can include an external storage device 710, a bus 720, a main memory 730, a read only memory 740, a mass storage device 750, communication port 760, and a processor 770. A person skilled in the art will appreciate that the computer system may include more than one processor and communication ports. Examples of processor 770 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 770 may include various modules associated with embodiments of the present invention. Communication port 760 can be any of an RS-232 port for use with a modem based dialup connection, a 10/100 Ethernet port, a Gigabit or 10 Gigabit port using copper or fiber, a serial port, a parallel port, or other existing or future ports. Communication port 760 may he chosen depending on a network, such a Local Area Network (LAN), Wide Area Network (WAN), or any network to which computer system connects. Memory 730 can be Random Access Memory (RAM), or any other dynamic storage device commonly known in the art. Read-only memory 740 can be any static storage device(s) e.g., but not limited to, a Programmable Read Only Memory (PROM) chips for storing static information e.g., start-up or BIOS instructions for processor 770. Mass storage 750 may be any current or future mass storage solution, which can be used to store information and/or instructions. Exemplary mass storage solutions include, but are not limited to. Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g.

those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 720 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system.

Optionally, operator and administrative interfaces, e.g. a display, keyboard, and a cursor control device, may also be coupled to bus 720 to support direct operator interaction with a computer system. Other operator and administrative interfaces can be provided through network connections connected through communication port 760. The external storage device 710 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, the present disclosure provides a unique and inventive solution for efficiently conducting life-cycle engagement of a candidate without human intervention on device engagement architecture, thus providing an automated solution to reduce/remove the human dependency of engagement or hiring process. The solution offered by the present disclosure ensures that the evaluation is consistent as well as accurate/precise due to the involvement of well-trained AI engine. Further, the implementation of blockchain allows authentic verification means to avoids fraudulent submission of information, which can enable to maintain reputation of organization that engages with the candidate. Further, the on-boarding and the joining process is also completely automated by implementation of the system and method of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We Claim:

1. A system for conducting life-cycle engagement of a candidate without human intervention on device engagement architecture, said system comprising a processor that executes a set of executable instructions that are stored in a memory, upon which execution, the processor causes the system to:
select initially, from a plurality of potential candidates, at least one candidate based on any or a combination of pre-screening of said plurality of candidates based on a set of pre-defined requirement rules, and assessment with respect to multiple engagement criteria, said initial selection being performed automatically based on responses of each of said plurality of potential candidates to real-time queries being generated in view of the multiple engagement criteria, wherein candidature of said plurality of potential candidates is received in response to a released vacancy that is determined. based on a set of pre-defined vacancy rules;
evaluate, through an AI engine, said at least one candidate, based on responses to one or more responsive video frames generated by said AI engine, said one or more responsive video frames being indicative of a second set of queries, each of said second set of queries being generated based on response by said least one candidate to a first set of queries;
based on a combination of said pre-screening, said assessment, and said AI engine based evaluation, generate a score for said at least one candidate, wherein said candidate being finally engaged based on the generated score.

2. The system as claimed in claim 1, wherein, upon a confirmed engagement of said candidate, said system transmits a first set of data packets indicative of confirmation of engagement of said candidate, in response to which, computing device of said candidate transmits a second set of data packets indicative of acknowledgement of said confirmation,

3. The system as claimed in claim 2, wherein said first of data packets are indicative of an offered compensation and location to said engaged candidate.

4. The system as claimed in claim 2, wherein in case the second set of data. packets are not transmitted by said computing device in a defined time-duration, the first set of data packets are automatically transmitted to a second candidate having next higher score to said engaged candidate,

5. The system as claimed in claim 2, wherein said second set of data packets comprises one or more document information associated with the engaged candidate, and wherein upon receipt of said second set of data packets, said system verifies said one or more document information through said AI engine, upon successful verification of which, a third set of data packets are transmitted to said engaged candidate indicative of pre-boarding of said candidate.

6. The system as claimed in claim 1, wherein upon a confirmed engagement of said candidate, said processor performs blockchain based profile and integrity verification of said engaged candidate, upon successful verification of which, a fourth set of data packets are transmitted to said engaged candidate indicative of joining confirmation of said candidate.

7. The system as claimed in claim 6, wherein on the date of said joining of said engaged candidate, computing device of said engaged candidate transmits, to said blockchain, a fifth set of data packets that are indicative of physical presence and joining of said engaged candidate, in response to which, said processor configures the blockchain to generate a sixth set of data packets indicative of facial recognition verification of said engaged candidate, and upon successful facial recognition verification, communication of identification information assigned to said engaged candidate.

8. The system as claimed in claim 1, wherein said set of pre-defined requirement rules comprise candidate profile screening rules.

9. The system as claimed in claim 1, wherein said multiple engagement criteria comprise aptitude-based evaluation, technical evaluation, and behavioural evaluation.

10. A method for conducting engagement of a candidate without human intervention, said method being executed by a processor, and comprising:
selecting initially, from a plurality of potential candidates, at least one candidate based on any or a combination of pre-screening of said plurality of candidates based on a set of pre-defined requirement rules, and assessment with respect to multiple engagement criteria, said initial selection being performed automatically based on responses of each of said plurality of potential candidates to real-time queries being generated in view of the multiple engagement criteria, wherein candidature of said plurality of potential candidates is received in response to a released vacancy that is determined based on a set of pre-defined vacancy rules;
evaluating, through an AI engine, said at least one candidate, based on responses to one or more responsive video frames generated by said AI engine, said one or more responsive video frames being indicative of a second set of queries, each of said second set of queries being generated based on response by said least one candidate to the previous query;
based on a combination of said pre-screening, said assessment, and said AI engine based evaluation, generating a score for said at least one candidate, wherein said candidate being finally engaged based on the generated score.
